(19) United States
(12) Patent Application Publication
(10) Pub. No.: US 2015/0158003 A1
(43) Pub. Date: Jun. 11, 2015

(54) MICROCAPSULES HAVING ACRYLIC POLYMERIC SHELLS AND METHODS OF MAKING SAME

(71) Applicant: Microtek Laboratories, Inc., Dayton, OH (US)

(72) Inventors: Teresa T. Virgallito, Beavercreek, OH (US); Carl M. Lentz, Waynesville, OH (US); David R. Virgallito, Beavercreek, OH (US); Dale E. Work, London, OH (US)

(21) Appl. No.: 14/561,473

(22) Filed: Dec. 5, 2014

Related U.S. Application Data
(60) Provisional application No. 61/912,819, filed on Dec. 6, 2013.

(51) Int. Cl. B01J 13/18

(52) U.S. Cl. CPC B01J 13/185

(57) ABSTRACT

Microcapsules are described that include a hydrophobic core material within an acrylic polymeric shell that was polymerized from a monomeric blend that includes a mono-functional acrylic monomer as less than 25% by weight of the monomeric blend and a hyperbranched polyester acrylic oligomer as the balance of the monomeric blend, and methods of making the same. The methods include a two-stage polymerization process where the monomeric blend is polymerized with an azo-initiator in a first stage polymerization reaction and is subsequently further polymerized with a water soluble initiator in a second stage polymerization reaction.

### RELATED APPLICATIONS

This application claims the benefit of U.S. Provisional Application No. 61/912,819, filed Dec. 6, 2013.

### TECHNICAL FIELD

The present application relates to microcapsules having a hydrophobic core material within an acrylic polymeric shell and methods of making such microcapsule. More particularly, the present application relates to microcapsules where the acrylic polymeric shell was emulsion polymerized from a monomeric blend that includes a mono-functional acrylic monomer as less than 25% by weight of the monomeric blend and a hyperbranched polyester acrylic oligomer as the balance of the monomeric blend in a two-stage polymerization process utilizing an azo-initiator in the first stage and a water soluble initiator in the second stage.

### BACKGROUND

Microcapsules can be constructed of various types of wall or shell materials to house varying core material for many purposes. The encapsulation process is commonly referred to as microencapsulation. Microencapsulation is the process of surrounding or enveloping one substance, often referred to as the core material, within another substance, often referred to as the wall, shell, or capsules, on a very small scale. The scale for microcapsules may be from less than one micron to several hundred microns in size. The microcapsules may be spherically shaped, with a continuous wall surrounding the core, while others may be asymmetrical and variably shaped.

General encapsulation processes include emulsion polymerization, bulk polymerization, solution polymerization, and/or suspension polymerization and typically includes a catalyst. Emulsion polymerization occurs in a water/oil or oil/water mixed phase. Bulk polymerization is carried out in the absence of solvent. Solution polymerization is carried out in a solvent in which both the monomer and subsequent polymer are soluble. Suspension polymerization is carried out in the presence of a solvent (usually water) in which the monomer is insoluble and in which it is suspended by agitation. To prevent the droplets of monomers from coalescing and to prevent the polymer from coagulating, protective colloids are typically added.

For certain applications, a desirable core or core material may be one that includes a phase change material (“PCM”). A PCM is a substance with a high heat of fusion which, melting and solidifying at a certain temperature, is capable of storing and releasing large amounts of energy. Heat is absorbed or released when the material changes from solid to liquid and vice versa; thus, PCMs are classified as latent heat storage units. The latent heat storage can be achieved through solid-solid, solid-liquid, solid-gas and liquid-gas phase change, but solid-liquid is typically used in thermal storage applications as being more stable of gas phase changes as a result of the significant changes in volume occupied by the PCM.

PCMs as latent heat storage devices have been used in textiles, building materials, packaging, electronics, etc. For example, the PCM may be encapsulated and included in a winter jacket as a microcapsule. The microcapsule, specifically the PCM, would initially absorb the wearer's body heat and store it (via melting of the PCM) until the body temperature drops from the outside temperature, at which time, the heat stored in the PCM is released (via solidification of the PCM) thereby giving warmth to the skier. Throughout the process the capsule wall contains the PCM.

Since the development of microencapsulated PCMs there has been a constant need for improved microcapsules, in particular there is a need for improvement in the thermostability and for higher enthalpy values for larger microcapsules having particle sizes greater than 10 microns and over a wide range of particle sizes.

### SUMMARY

In one aspect, microcapsules having a hydrophobic core material within an acrylic polymeric shell, in which the acrylic polymeric shell was produced in a two-stage polymerization process are described. The microcapsules include an acrylic polymeric shell that was polymerized from a monomeric blend that includes a mono-functional acrylic monomer as less than 25% by weight of the monomeric blend and a hyperbranched polyester acrylic oligomer as the balance of the monomeric blend, and methods of making the same.

The microcapsules produced in the two stage polymerization process have an average mean particle size diameter range of 5 to 60 microns.

In another aspect, methods of making acrylic microcapsules in a two-stage polymerization process are described. The two-stage polymerization process includes forming a monomeric blend, emulsion polymerizing an organic phase comprising core material and the monomeric blend in the first stage. The first stage includes an azo-initiator in the polymerization reaction and thereby forming a polymerized intermediate in capsule form. The second stage includes further polymerizing the polymerized intermediate from the first stage with a water soluble initiator to form microcapsules. The water soluble initiator may be a persulfate or a water soluble azo-initiator.

In the first stage, forming the monomeric blend may include blending at least one hyperbranched polyester acrylic oligomer with at least one di-functional crosslinking acrylic monomer or mono-functional acrylic monomer or with at least one each of a di-functional crosslinking acrylic monomer and a mono-functional acrylic monomer to form a monomeric blend. The first stage may also include mixing the monomeric blend in an aqueous polymer solution to form an emulsion of oil droplets.

In one embodiment, the azo-initiator may be included in the blending of/within the monomeric blend to form a monomeric-initiator blend. The first stage may also include heating the emulsion to activate the azo-initiator to form the polymerized intermediate. In another embodiment, the azo-initiator may be added, during the first stage, by titration into the organic phase as an aqueous solution.

In the second stage, the water soluble initiator is added by titration as an aqueous solution to the polymerized intermediate. Subsequent to the titration, the second stage includes curing and thereafter cooling to terminate the polymerization reaction and thereby forming the microcapsules.

### BRIEF DESCRIPTION OF THE DRAWINGS

FIG. 1 is a flow chart diagram of a two-stage polymerization process for making acrylic microcapsules.

FIG. 2 is a graph of the Melt ΔH % Retention and the TGA % Retention of microcapsules for the Examples disclosed herein after fifty thermal cycles.

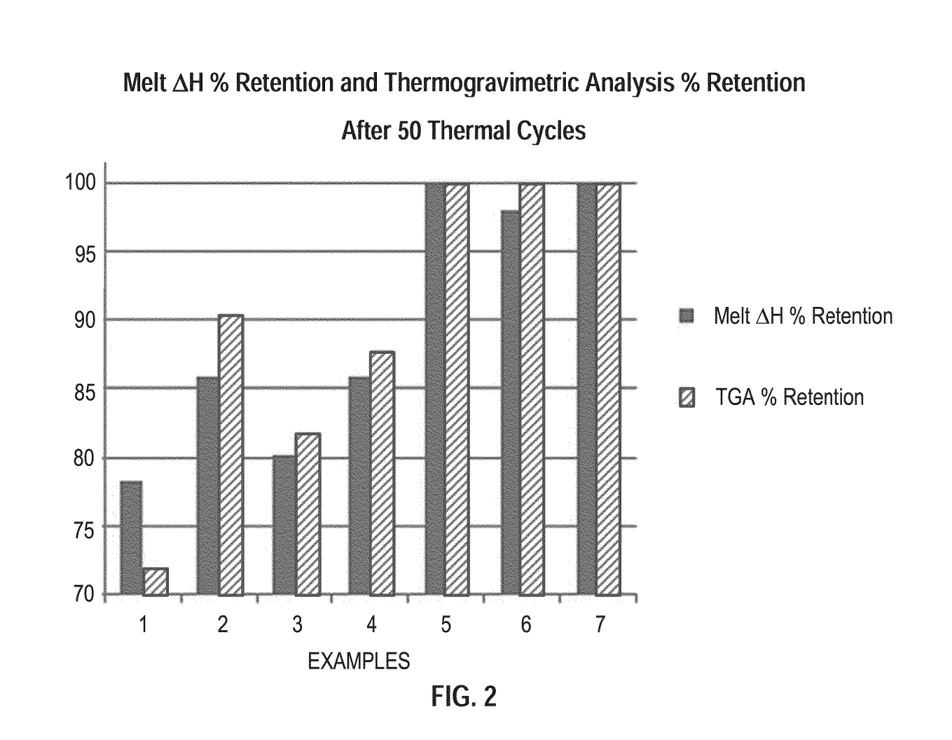

### DETAILED DESCRIPTION

The following detailed description will illustrate the general principles of the invention, examples of which are additionally illustrated in the accompanying drawings. In the drawings, like reference numbers indicate identical or functionally similar elements.

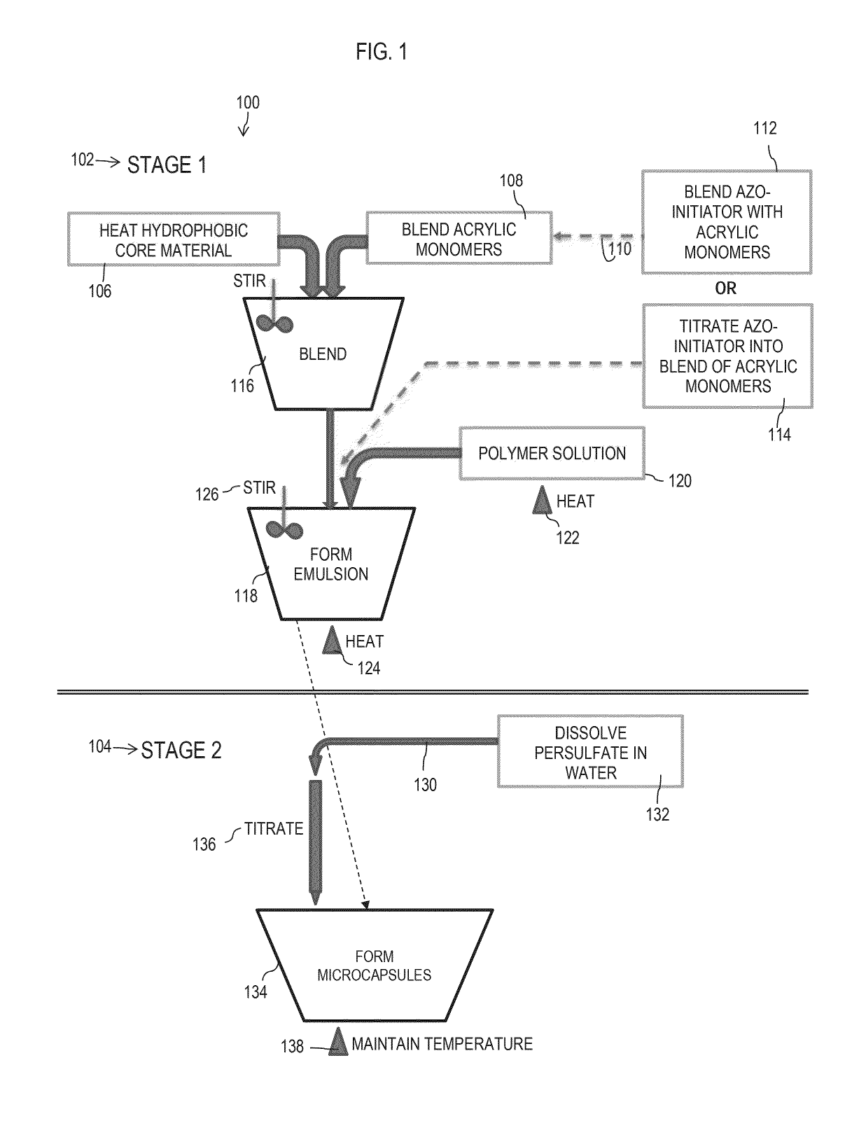

Referring to FIG. 1, a flow chart is depicted that represents an overview of a process 100 for producing microcapsules, in particular, microcapsules having a hydrophobic core material within an acrylic polymeric shell. The process 100 is a two-stage process having a first polymerization during a first stage 102 and a second polymerization during a second stage 104. Here, even though the process is a two-stage process, the final microcapsules have a single acrylic polymeric shell encapsulating the hydrophobic core materials. The first polymerization and the second polymerization may both be radical polymerization reactions activated by use of an initiator, but the initiator used in the second stage 104 is not the same as the initiator used in the first stage 102. The microcapsules produced by this two stage polymerization have an average mean particle diameter of about 5 to about 60 μm and superior thermodynamic and kinetic properties exemplified by a decomposition temperature greater than 225° C. and an enthalpy (ΔH) greater than 120 J/g. Also, the microcapsules exhibit superior thermo-cycle properties, e.g., the microcapsules have a percent retention of enthalpy of greater than 85% and a percent retention of decomposition temperature of greater than 85% after 50 cycles where each cycle includes cycling the temperature between 10° C. and 60° C. for a 175 minute cycle, for example in a Micro Climate Oven available from CSZ (Cincinnati Sub Zero) Industrial Division. The cycle should include increases and decreases in temperature within the 10° C. and 60° C. temperature range to test the acrylic polymeric shell's integrity after expanding and contracting repeatedly.

The first stage 102 includes heating one or more hydrophobic core materials 106 and, separately, blending or mixing together acrylic monomers 108 (referred to as a monomer or monomeric blend) with an azo-initiator added 110 thereto (now referred to as a monomeric-initiator blend), which may be carried out at ambient conditions, and then secondly blending or mixing 116 the hydrophobic core material 106 with the acrylic monomeric blend that includes the azo-initiator with heat and stirring. The blend 116 at this point in the first stage 102 may be referred to as an organic phase. In one embodiment, the organic phase has a flash point that is greater than 50° C. As depicted in the flow chart, the azo-initiator may be blended 112, simultaneously or sequentially, with the acrylic monomers 108 or titrated 114 into the emulsion 118. In adding the azo-initiator to the acrylic monomers 108, the mixture is blended or mixed until the azo-initiator is dissolved in the acrylic monomers 108.

Next, but still in the first stage 102, an emulsion 118 is formed by bringing the blend 116 into contact with a polymer solution 120. The polymer solution 120 may be added to the blend 116 or the blend 116 may be added to the polymer solution 120 with heat 124 and stirring 126. The polymer solution 120 may be a water soluble polymer solution and may be heated 122 before addition to the blend 116. In one embodiment, the organic phase is added to the water soluble polymer solution with a stirring speed greater than 100 rpm to form a coarse emulsion with mean particle diameters of greater than 100 μm. The organic phase is further mixed into the water soluble polymer solution at a temperature of greater than 50° C. using high shear mixing to form oil droplets with an average mean particle diameter of about 5 to 60 μm. The emulsion 118 containing the oil droplets is then heated to at least 80° C. to initiate the polymerization of the acrylic monomers with the azo-initiator and is maintained at such a temperature for enough time to cure the polymerized acrylic monomers. This completes the first stage 102 with the formation of intermediate microcapsules, also referred to herein as a polymerized intermediate, each having an acrylic polymeric shell.

Still referring to FIG. 1, the second stage 104 includes further polymerizing the intermediate microcapsules from the first stage 102 to form the final microcapsules 134 by addition 130 of a water soluble initiator, for example a persulfate 132 dissolved. The persulfate 132 is merely one example of a water soluble initiator and the process is not limited thereto. Suitable persulfate initiators include, but are not limited to, ammonium persulfate and potassium persulfate. Other water soluble initiators include water soluble azo-initiators including those identified above. The water soluble initiator may be provided as an aqueous solution or the process may include a step of dissolving the water soluble initiator in water to form an aqueous solution. The persulfate 132 is titrated 136 into the emulsion 118 from the first stage 102. The emulsion 118 is maintained 138 at least 80° C. for such time to cure the acrylic polymers created by the polymerization reaction with the persulfate. Once the polymerization is complete the temperature is reduced to terminate the reaction. In one embodiment, the temperature is reduced rapidly to about 20° C. to terminate the reaction. The microcapsules may be washed and filtered after termination of the reaction. In one embodiment, the microcapsules are washed and then filtered on a continuous belt filter and/or a centrifuge to remove residual monomers. The microcapsules can be reduced to a microcapsule slurry, a microcapsule cake with percent solids of 50 to 80% solids, or a microcapsule dry powder depending upon a customer's needs and shipping expense.

The blend of acrylic monomers 108 (FIG. 1) includes a hyperbranched polyester acrylic oligomer and at least one of a mono-functional acrylic monomer and a di-functional crosslinking acrylic monomer. In one embodiment, the blend of acrylic monomers 108 includes at least one hyperbranched polyester acrylic oligomer, at least one mono-functional acrylic monomer, and at least one di-functional crosslinking acrylic monomer. In another embodiment, the blend of acrylic monomers 103 includes at least one hyperbranched polyester acrylic oligomer and at least one mono-functional acrylic monomer. In another embodiment, the blend of acrylic monomers 103 includes at least one hyperbranched polyester acrylic oligomer and at least one di-functional crosslinking acrylic monomer.

The microcapsules formed by the two-stage process may have varying percent weight amounts of the acrylic monomers 108 in the blend thereof (referred to herein as the “monomeric blend,” which does not include the azo-initiator in the calculations). In one embodiment, when the mono-functional acrylic monomer is present it comprises less than 25% by weight of the monomeric blend. In one embodiment, the mono-functional acrylic monomer is present as at most 23% by weight of the monomeric blend. In other embodiments, the mono-functional acrylic monomer is at most 20% by weight or at most 15% by weight of the monomeric blend. Thus, the mono-functional acrylic monomer may compose from 0% to 25% by weight of the monomeric blend, or 0% to 23% by weight of the monomeric blend, or from 0% to 20% by weight of the monomeric blend. The microcapsules formed by the two-stage process include a hyperbranched polyester acrylic oligomer as the balance of the monomeric blend if the only other monomer is the mono-functional acrylic monomer.

In an embodiment where the monomeric blend includes at least one hyperbranched polyester acrylic oligomer, at least one mono-functional acrylic monomer, and at least one di-functional crosslinking acrylic monomer, the mono-functional acrylic monomer is present within the ranges or amounts discussed above. Accordingly, the balance of the monomeric blend is split between the hyperbranched polyester acrylic oligomer and the di-functional crosslinking acrylic monomer and may be split equally (or unequally). The hyperbranched polyester acrylic oligomer may be about 25-53% by weight of the monomeric blend. The di-functional crosslinking acrylic monomer may be about 25-53% of the monomeric blend. In the embodiment of Example 5 in Table 2 below, the mono-functional acrylic monomer is present as 23% by weight of the monomeric blend and the hyperbranched polyester acrylic oligomer and the di-functional crosslinking acrylic monomer are both present as 38.5% by weight of the monomeric blend. In the embodiment of Example 6 in Table 2 below, the mono-functional acrylic monomer is present at 20% by weight of the monomeric blend and the hyperbranched polyester acrylic oligomer and the di-functional crosslinking acrylic monomer are both present as 40% by weight of the monomeric blend. In the embodiment of Example 7 in Table 2 below, the mono-functional acrylic monomer is present at 14.2% by weight of the monomeric blend and the hyperbranched polyester acrylic oligomer and the di-functional crosslinking acrylic monomer are both present as 42.9% by weight of the monomeric blend. These example embodiments demonstrate superior thermodynamic and kinetic properties exemplified by a decomposition temperature greater than 225° C. and an enthalpy (ΔH) greater than 120 J/g, which are desirable for many customers' needs. However, the method described herein is also capable of making microcapsules with other percent by weight amounts of the acrylic monomers outside of the ranges disclosed above for monomeric blend and as such the process should not be construed as limited to these amounts.

### First Stage Components

The hydrophobic core material 106 includes a heat-absorbing material that has a melting point at about −30° C. to about 70° C. and is selected from a group consisting of straight chain alkanes, alcohols, organic acids, and aliphatic acid containing at least 6 carbon atoms. The hydrophobic core material 106 is typically heated during the first stage 102 of the process 100 to put the material in the liquid phase for ease of mixing with the other components utilized in the process 100. Examples of suitable hydrophobic core materials include, but are not limited to, aliphatic hydrocarbyl compounds such as saturated or unsaturated C₁₀-C₄₀ hydrocarbons, which are branched or preferably linear; cyclic hydrocarbons; aromatic hydrocarbyl compounds; C₁-C₄₀-alkyl-substituted aromatic hydrocarbons; saturated or unsaturated C₆-C₃₀-fatty acids; fatty alcohols; Cesters; and natural and synthetic waxes.

Examples of saturated or unsaturated C₁-C₄₀ hydrocarbons, which are branched or preferably linear, include, but are not limited to n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane. Examples of cyclic hydrocarbons include, but are not limited to, cyclohexane, cyclooctane, cyclodecane. Examples of aromatic hydrocarbyl compounds include, but are not limited to, benzene, naphthalene, biphenyl, o- or n-terphenyl. Examples of C₁-C₄₀-alkyl-substituted aromatic hydrocarbons include, but are not limited to, dodecylbenzene, tetradecylbenzene, hexadecylbenzene, hexylnaphthalene or decyinaphthalene. Examples of saturated or unsaturated C₆-C₃₀-fatty acids include, but are not limited to, lauric, stearic, oleic or behenic acid, and eutectic mixtures of decanoic acid with myristic, palmitic or lauric acid. Examples of fatty alcohols include, but are not limited to, lauryl, stearyl, oleyl, myristyl, cetyl alcohol, mixtures such as coconut fatty alcohol, and the so-called oxo alcohols which are obtained by hydroformylation of α-olefins and further reactions. Examples of Cesters include, but are not limited to, C₁-C₁₀-alkyl esters of fatty acids, such as propyl palmitate, methyl stearate or methyl palmitate, and their eutectic mixtures or methyl cinnamate. Examples of natural and synthetic waxes include, but are not limited to, montan acid waxes, montan ester waxes, polyethylene wax, oxidized waxes, polyvinyl ether wax, ethylene vinyl acetate wax.

The hyper-branched polyester acrylate oligomer has low viscosity with a Tg (glass transition temperature) of >70° C. and a functionality>5. “Functionality” refers to chemical reactivity of a substance. Examples of suitable hyper-branched polyester acrylate oligomers include, but are not limited to, products such as Sartomer CN2302, Sartomer CN2303, and Sartomer CN2304. The suitable hyper-ranched polyester acrylate oligomers available from Sartomer are described by Sartomer as highly branched three-dimensional materials that differ structurally from the linear or lightly branched products typically used in radiation-cured systems, as having an approximately spherical or globular morphology with having a saturated backbone with terminal acrylate groups, and as having an end group concentration that remains relatively constant as the molecular weight thereof increases. Because of the approximately spherical or globular morphology, the properties of hyper-branched polymers differ from traditional linear polymers in that they have relatively low molecular volume for a given molecular weight and have a high concentration of end groups.

The mono-functional acrylic monomer is typically a neutral mono-functional acrylic monomer. Examples of suitable neutral mono-functional acrylic monomers include, but are not limited to, N-(n-Octadecyl)acrylamide, acrylamide, N-acryloylmorpholine, t-amyl methacrylate, benzhydryl methacrylate, benzyl acrylate, benzyl methacrylate, N-benzylmethacrylamide, 2-n-butoxyethyl methacrylate, t-butyl acrylate, n-butyl acrylate, t-butyl methacrylate, iso-butyl methacrylate, n-butyl methacrylate, sec-butyl methacrylate, 4-chlorophenyl acrylate, cyclohexyl acrylate, cyclohexyl methacrylate, iso-decyl acrylate, iso-decyl methacrylate, n-decyl methacrylate, N,N-diethylacrylamide, N,N-dimethylacrylamide, N,N-dimethylmethacrylamide, N,N-diphenyl methacrylamide, n-dodecyl acrylate, n-dodecyl methacrylate, N(n-dodecyl)methacrylamid, 2-(2-ethoxyethoxy)ethyl acrylate, 2-ethylhexyl acrylate 2-ethylhexyl acrylate 2-ethylhexyl acrylate, N-ethylmethacrylamide, 1-hexadecyl methacrylate, n-hexyl acrylate, 2-methoxyethyl acrylate, 2-methoxyethyl methacrylate, methyl methacrylate, 2-naphthyl acrylate, n-octyl methacrylate, N-(tert-octyl)acrylamide, pentabromophenyl acrylate, pentabromophenyl methacrylate, pentafluorophenyl acrylate, pentafluorophenyl methacrylate, 2-phenoxyethyl methacrylate, phenyl acrylate, phenyl methacrylate, 2-phenylethyl acrylate, 2-phenylethyl methacrylate, n-propyl acrylate, n-propyl methacrylate, N-iso-propylacrylamide, stearyl acrylate, tribromoneopentyl methacrylate, 2,4,6-tribromophenyl acrylate, triethylene glycol monomethyl ether monomethacrylate, 3,3,5-trimethylcyclohexyl methacrylate, and undecyl methacrylate.

Examples of suitable di-functional crosslinking acrylic monomers include, but are not limited to, 2,2-bis[4-(2-acryloxyethoxy) phenyl] propane, barium methacrylate, bis(2-methacryloxyethyl) phosphate, bis(2-methacryloxyethyl)-N,N′-1,9-nonylene biscarbamate, 2,2-bis(4-methacryloxyphenyl) propane, 2,2-bis[4-(2-hydroxy-3-methacryloxypropoxy)phenyl] propane, 1,4-butanediol diacrylate, 1,3-butanediol dimethacrylate, 1,4-butanediol dimethacrylate, copper (II) methacrylate, trans-1,4-cyclohexanediol dimethacrylate, N,N′-cystaminebisacrylamide, 1,10-decanediol dimethacrylate, 1,4-diacryloylpiperazine, N,N′-diallylacrylamide, diethylene glycol diacrylate, diethylene glycol dimethacrylate, 2,2-dimethylpropanediol dimethacrylate, dipropylene glycol dimethacrylate, N,N′-ethylene bisacrylamide, ethylene glycol diacrylate, ethylene glycol dimethacrylate, fluorescein dimethacrylate, N,N′-hexamethylenebisacrylamide, 1,6-hexanediol diacrylate, 1,6-hexanediol dimethacrylate, magnesium acrylate, N,N′-methylenebisacrylamide, nonanediol dimethacrylate, 1,5-pentanediol dimethacrylate, 1,4-phenylene diacrylate, tetraethylene glycol dimethacrylate, triethylene glycol diacrylate, triethylene glycol dimethacrylate, and zinc dimethacrylate.

The azo-initiator has the general formula of R—N═N—R′. In one embodiment, the azo-initiator is oil soluble. Examples of suitable oil soluble azo-initiators include, but are not limited to, 2,2′-azobis(4-methoxy-2,4-dimethyl valeronitrile; 2,2′-Azobis(2,4-dimethyl valonitrile); dimethyl 2,2′-azobis(2-methylpropionate); 2,2′-azobis(2-methylbutyronitrile); 1,1′-azobis(cyclohexane-1-carbonitrile); 2,2′-azobis[N-(2-propenyl)-2-methylpropionamide]; 1-[(1-cyano-1-methylethyl)azo]formamide; 2,2′-azobis(N-butyl-2-methylpropionamide]; 2,2′-azobis(N-cyclohexyl-2-methylpropionamide); 2,2′-azobis(2-methylpropionitrile); 1,1′-azobis(cyclohexanecarbonitrile).

In another embodiment, the azo-initiator is soluble in water. Examples of suitable water soluble azo-initiators include, but are not limited to, 2,2′-azobis(1-imino-1-pyrolidino-2-ethylpropane)dihydrochloride; 2,2′-azobis{2-methyl-N-[1,1-bis(hydroxymethyl)-2-hydroxyethl]propionamide}; 2,2′-azobis[2-methyl-N-(2-hydroxyethyl)propionamide]; 2,2′-azobis[2-(2-imidazolin-2-yl)propane].

The polymer solution includes water soluble polymers such as, but not limited to, hydrolyzed polyvinyl alcohol, polyvinyl acetate, polyvinyl acetal, polyvinyl butyral, ethylene maleic anhydride, sorbitan monostearate, sorbitan monooleate, sorbitan monolaurate, sorbitan mono-isostearate, amylopectin, amylase, pectins, bacterial polysaccharides, chitosan, gum Arabic, agar, alginate, carrageenans, laminarin, cellulose derivatives, and starch derivatives. The cellulose derivatives may include carboxymethyl, hydroxyethyl, methyl cellulose, which are derivatives made by formation of a soda cellulose complex of cellulose (with NaOH) and then treatment with ClCH₂COONa, ethylene oxide, or methanol, respectively. The starch derivatives may include ethoxy, amino- (cationic) starch.

### Second Stage Components

In the second stage 104 of FIG. 1, persulfate is shown as an example of a water soluble initiator, but the method is not limited thereto, titrated into the polymerized intermediate from stage one, emulsion 118. Suitable persulfate initiators include, but are not limited to, ammonium persulfate and potassium persulfate. Other water soluble initiators include water soluble azo-initiators including those identified above. The water soluble initiator may be present as about 0.01 to 0.75% of the wet weight of composition in stage two of the polymerization process.

### COMPARATIVE EXAMPLES

TABLE 1

| | Example | Example | Example | Example |
|---|---|---|---|---|
| | 1 Wet | 2 Wet | 3 Wet | 4 Wet |
| Ingredients | Wt (g) | Wt (g) | Wt (g) | Wt (g) |
| Deionized Water | 254 | 254 | 254 | 254 |
| PVA 540 dry powder | 6 | 6 | 6 | 6 |
| n-Octadecane Wax | 190 | 190 | 190 | 190 |
| Methyl Methacrylate | 18 | 18 | 25.25 | 25.25 |
| 1,4-Butanediol | 10 | 10 | 17.25 | 17.25 |
| Diacrylate | | | | |
| Trimethylopropane | 14.5 | 14.5 | — | — |
| Trimethacrylate SR350 | | | | |
| t-Butyl Peroxypivillate | 2.3 | 2.3 | 2.3 | 2.3 |
| 75% | | | | |
| stearic acid | 1.9 | 1.9 | 1.9 | 1.9 |
| Total | 496.7 | 496.7 | 496.7 | 496.7 |
| % solids | 47.5 | 47.5 | 47.4 | 47.5 |
| % Methyl Methacrylate | 42.35 | 42.35 | 64.3 | 64.3 |
| in the Monomeric Blend | | | | |
| % 1,4-Butanediol | 23.5 | 23.5 | 35.7 | 35.7 |
| Diacrylate in the | | | | |
| Monomeric Blend | | | | |
| Trimethylopropane | 34.1 | 34.1 | — | — |
| Trimethacrylate SR350 | | | | |
| Particle size | 19.6 | 4.2 | 20.1 | 2.9 |
| (Mean in μm) | | | | |
| Core to Wall ratio | 81:19 | 81:19 | 81:19 | 81:19 |

Examples 1-4 in Table 1 above are comparative examples based on the disclosure and working examples in U.S. Published Application No. 2012/0076843. The microcapsules for the comparative examples 1-4 were made as follows. A 2.5% PVA 540 solution was made by heating deionized water and PVA 540 crystals to 90° C. with stirring. Once the solution reached 90° C., it was stirred for 30 minutes. The solution was then cooled to 50° C. The n-octadecane wax was heated to 65° C. and the stearic acid was added to the wax at 65° C. with stirring, and mixed for 30 minutes. The wax was then cooled to 50-55° C. The monomers, methyl methacrylate, 1,4-butanediol diacrylate, and trimethylolpropane trimethacyrlate SR350 were blended at room temperature with stirring, and t-butyl peroxypivilate 75% was added to the monomeric blend at room temperature with stirring. The monomer/initiator blend was added to the wax at 50-55° C. with stirring, and mixed for 15 minutes (now referred to as the “organic phase”). The organic phase was added to a water soluble polymer solution with stirring at a stirring speed>100 rpm and a coarse emulsion was formed with a mean particle size diameter of >100 microns. The temperature of the emulsion was at 50-55° C. A step wise heating cure was run on the batch. After emulsification the batch was raised to 60° C. over a 20 minute ramp time. The batch was cured at 60° C. for 60 minutes. The temperature of the batch was then raised to 70° C. over a 20 minute ramp time. The batch was cured at 70° C. for 60 minutes. The temperature of the batch was then raised to 85° C. over a 40 minute ramp time. The batch was cured at 85° C. for 60 minutes. After 1 hour at 80° C. the batch is rapidly cooled to 18° C. to terminate the reaction.

Example 1 was emulsified to obtain a mean particle size of 19.6 microns. After batch completion, the slurry was filtered and washed on a Buchner funnel, the capsule cake was submitted for testing. Example 2 was emulsified to obtain a mean particle size of 4.2 microns. Example 3 was emulsified to obtain a mean particle size of 20.12 microns. Example 4 was emulsified to obtain a mean particle size of 2.9 microns.

### Inventive Examples 5-7

| | Example | Example | Example |
|---|---|---|---|
| | 5 Wet | 6 Wet | 8 Wet |
| Ingredients | Wt (g) | Wt (g) | Wt (g) |
| First stage polymerization | | | |
| Deionized Water | 508 | 508 | 508 |
| PVA 540 dry powder | 12 | 12 | 12 |
| n-Octadecane Wax | 280 | 380 | 380 |
| Methyl Methacrylate | 15 | 15 | 10 |
| 1,4-Butanediol Diacrylate | 25 | 30 | 30 |
| CN2302 polyester Acrylate Oligomer | 25 | 30 | 30 |
| 2,2′-Azobis(2-methylpropionitrile) | 1.2 | 1.2 | 1.2 |
| Second stage polymerization | | | |
| Deionized Water | 200 | 200 | 200 |
| Ammonium Persulfate | 1 | 1 | 1 |
| Deionized Water | 50 | 50 | 50 |
| stearic acid | 3.8 | 3.8 | 3.8 |
| Total | 1221 | 1231 | 1226 |
| % solids | 37.7 | 38.2 | 38 |
| % Methyl Methacrylate in | 23 | 20 | 14.2 |
| the Monomeric Blend | | | |
| % 1,4-Butanediol Diacrylate | 38.5 | 40 | 42.9 |
| in the Monomeric Blend | | | |
| % CN2302 polyester Acrylate | 38.5 | 40 | 42.9 |
| Oligomer in the Monomeric Blend | | | |
| Total % Monomeric Blend in | 14 | 15.8 | 14.9 |
| the composition | | | |
| Core to Wall ratio | 85:15 | 84:16 | 84:16 |

The acrylic microcapsules made according to the compositions presented in Table 2 above for Inventive Examples 5-7 were made using the two stage polymerization method disclosed herein. In the first stage of polymerization an organic blend was formed by heating the n-octadecane wax (a hydrophobic core) in a reactor, blending the CN2302 polyester Acrylate Oligomer (a hyper-branched polyester acrylate oligomer), the 1,4-butanediol diacrylate (a di-functional crosslinking acrylic monomeric), the methyl methacrylate (a neural mono functional monomer) and the 2,2′-azobis(2-methylpropionitrile) (an azo-initiator) at ambient conditions until the azo-initiator is dissolved in the monomers, and adding the monomeric-azo-initiator blend to the hydrophobic core in a reactor with heat and stirring. The organic blend was a homogenous organic phase with a flash point>50° C. Next, the PVA 540 was added to the deionized water and heated to >50° C. in a jacketed tank. The organic blend was added to the PVA 540 solution (a water soluble polymer solution) with stirring speed>100 rpm and a coarse emulsion of particles having a mean particle diameter of >100 microns formed as oil droplets of the organic phase. The organic blend was emulsified in the water soluble polymer solution at >50° C. using high shear mixing to form an oil droplet with a volume weighted mean particle size in a range of 5 to 60 microns. The emulsion was heated to ≧85° C. so that the azo-initiator (R—N═N—R′) can initiate the polymerization and was thereafter cured for a minimum of 3 hours at ≧80° C. The pH of the emulsion during the first stage of polymerization cure was between a pH range of 3 to 3.5. Once the azo-initiator is depleted the pH of the emulsion containing the intermediate microcapsules increased to a pH>4.0.

In the second stage, the ammonium persulfate was dissolved in the deionized water to form a solution, which was then slowly titrated into the emulsion from the end of the first stage. The emulsion temperature was 85° C. while titrated with the ammonium persulfate. The emulsion was then cured for 2 hours at ≧85° C. The pH of the emulsion during this cure phase was between a pH range of 1.9 to 2.8. After the 2 hours at ≧85° C. , the batch was heated to >90° C. for 60 minutes and then rapidly cooled to 18° C. to terminate the reaction.

The microcapsules formed at the end of the second stage for each of Examples 5-7 and the microcapsules from Examples 1-4 were analyzed for particle size distribution using a Malvern Mastersizer 2000 Particle Analyzer, Free Wax by GC, and Percent Solids on a Denver Instrument IR-200 Solids Analyzer. The capsules were measured for melting point and total enthalpy (ΔH) of the melt curve in a differential scanning calorimetry model Perkin Elmer DSC 4000. The decomposition temperature of the capsules was measured by a thermogravimetric analyzer model Perkin Elmer TGA 4000. The capsules were also analyzed for percent free wax. The data from these various tests are reported in Table 3 for Examples 1-7.

TABLE 3

| | | | | | | | After 50 Thermal Cycles | | |
|---|---|---|---|---|---|---|---|---|---|
| | Microcapsules: After Formation | | | | | | | (TC-50) | |
| | | | TGA 10% | | | | | TGA 10% | (TC-50) |
| | Part. Size | % Free | Wt. Loss | | M Peak | MP ΔH | (TC-50) % | Wt. Loss | MP ΔH |
| Example No: | Mean (μ) | wax | @ ° C. | Solids | ° C. | (J/g) | Free wax | @ ° C. | (J/g) |
| 1 | 19.6 | 22.54 | 224 | 65.8 | 28.84 | 141.6 | 28.45 | 160.8 | 110.8 |
| 2 | 4.2 | 1.6 | 190.65 | 51.77 | 28.89 | 166.04 | 3.4 | 172.4 | 142.6 |
| 3 | 20.12 | 15.64 | 172.43 | 60.2 | 27.16 | 143.2 | 20.15 | 140.8 | 114.7 |
| 4 | 2.9 | 1.3 | 185.12 | 48.33 | 28.74 | 174.63 | 3.9 | 162.4 | 149.8 |
| 5 | 12.4 | 0.64 | 237.8 | 35.94 | 29.47 | 164.5 | 1 | 256.89 | 175.51 |
| 6 | 14.3 | 0.6 | 262.33 | 43.34 | 28.82 | 162.13 | 0.52 | 266.96 | 158.73 |
| 7 | 14.04 | 0.66 | 259.4 | 41.85 | 29.86 | 160.4 | 0.95 | 261.7 | 165.12 |

As seen from the data in Table 3, the Inventive Examples 5-7 have superior retention of the hydrophobic core material as evidenced by the % of free wax being below 1% in comparison to microcapsules of relatively comparable size as seen in Examples 1 and 3. Additionally, the Inventive Examples 5-7 are superior to the Comparative Examples in the decomposition temperature as reflecting the column “TGA 10% weight loss at ° C.” as measured using a thermogravimetric analyzer model Perkin Elmer TGA 4000. As reported in Table 2, the decomposition temperatures of the Inventive Examples 5-7 are between about 238° C. and 262° C., in contrast to the Comparative Examples 1-4 having decomposition temperatures between 172° C. and 224.

Comparative Examples 1-4 do not result in successful larger sized microcapsules. The microcapsules formed for Examples 1 and 3 were made to have an average mean particle size of about 20 microns, but poor wall formation results from the process disclosed above that utilized t-Butyl Peroxypivilate 75% as the initiator for the polymerization and step wise heating for the cure. The failure of these larger sized microcapsules was evident from the high percentage of free wax. Example 1 had 22.5% free wax and Example 3 had 15.6% free wax.

The microcapsules from the Comparative Examples 1-4 and the Inventive Examples 5-7 were tested for thermo cycle stability in a Cincinnati Sub Zero Micro Climate Oven after fifty (50) thermal cycles. One thermal cycle consisted of cycling in a temperature range of 10° C. to 60° C. for 175 minutes to test the effects of capsule expansion and contraction hours. After the fifty cycles, the microcapsules were measured for melting point and total enthalpy (ΔH) of the melt curve in a differential scanning calorimetry model Perkin Elmer DSC 4000. The decomposition temperature of the capsules was measured by a thermogravimetric analyzer model Perkin Elmer TGA 4000. Additionally, the percent of free wax was determined.

The microcapsules of Comparative Examples 1 and 3 exhibit poor thermo-cycle properties, with a percent retention of enthalpy ΔH of about 78-80% after ≧50 cycles and with a percent retention of decomposition temperature of about 71-82% after ≧50 cycles. In contrast, the Inventive Examples 5-7 unexpectedly show an increase in the decomposition temperature after the 50 cycles and at least about a 98% retention of the enthalpy (see Inventive Example 6) or an increase in the enthalpy after the 50 cycles.

Microcapsules of Comparative Examples 2 and 4 have an average mean particle size of about 2.9-4.2 microns. These capsules had good wall formation utilizing t-Butyl Peroxypivilate 75% as the initiator for the polymerization and a step wise heating for the curing of the acrylic polymers. The capsules have slightly higher % free wax values than the microcapsules of Inventive Examples 5-7, which have a percent of free wax<1%. The microcapsules of Examples 2 and 4 also have lower decomposition temperatures than the microcapsules of Inventive Examples 5-7. The microcapsules have similar enthalpy ΔH values since they include the same core material, n-octadecane wax, but the retention of the enthalpy after 50 cycles for the Comparative Examples 2 and 4 is significantly less than for the Inventive Examples. The enthalpy after 50 thermal cycles was reduced to about 86% of the enthalpy before thermal cycling for Comparative Examples 2 and 4, but was about 98% or better for the Inventive Examples.

The embodiments of this invention shown in the drawings and described above are exemplary of numerous embodiments that may be made within the scope of the appended claims. It is contemplated that numerous other configurations of microcapsules may be created by taking advantage of the disclosed two-stage polymerization method of making the microcapsules. In short, it is the applicants' intention that the scope of the patent issuing herefrom be limited only by the scope of the appended claims.

What is claimed is:

1. A method for producing microcapsules, the method comprising:
emulsion polymerizing, in a first stage, an organic phase comprising core material and acrylic monomers as wall material, the wall material being polymerized with an azo-initiator thereby forming a polymerized intermediate in capsule form; and
polymerizing further, in a second stage, the polymerized intermediate by addition of a water soluble initiator to form microcapsules.

2. The method of claim 1, wherein the water soluble initiator includes persulfate, water soluble azo-initiators, or combinations thereof.

3. The method of claim 1, wherein the second stage further comprises:
titrating the water soluble initiator as an aqueous solution into the polymerized intermediate.

4. The method of claim 3, further comprising, subsequent to titrating:
heating to a cure temperature, and thereafter cooling to terminate the polymerization reaction.

5. The method of claim 1, wherein the first stage further comprises:
blending at least one hyperbranched polyester acrylic oligomer with:
at least one di-functional crosslinking acrylic monomer or mono-functional acrylic monomer; or
at least one each of a di-functional crosslinking acrylic monomer and a mono-functional acrylic monomer to form a monomeric blend; and
mixing the monomeric blend in an aqueous polymer solution to form an emulsion of oil droplets.

6. The method of claim 5, wherein blending further comprises adding the azo-initiator to the monomeric blend to form an initiator-monomeric blend; and the method includes heating the emulsion to activate the azo-initiator to form the polymerized intermediate.

7. The method of claim 6, wherein the azo-initiator is oil soluble.

8. The method of claim 5, further comprising, in the first stage:
titrating the azo-initiator, as an aqueous solution, into the emulsion; and
heating the emulsion to activate the azo-initiator to form the polymerized intermediate.

9. The method of claim 1, wherein the microcapsules have a volume weight mean particle size in a range of about 5 μm to about 60 μm.

10. The method of claim 1, wherein the azo-initiator comprises about 0.01% to about 1.0% by dry weight of the microcapsules, and the water soluble initiator comprises about 0.01% to about 1.0% by dry weight of the microcapsules.

11. The method of claim 10, wherein the monomeric blend is about 5% to about 50% by dry weight of the microcapsules.

12. The method of claim 11, wherein the monomeric blend is about 10% to about 30% dry weight of the microcapsules.

13. The method of claim 5, wherein the hyper-branched polyester acrylate oligomer has a glass transition temperature (“Tg”) of >70° C. and a functionality >5.

14. The method of claim 11, wherein the hyper-branched polyester acrylate oligomer has a functionality of 12-16 and a structure having a spherical or globular morphology.

15. A microcapsule made by the method as claimed in claim 1.

16. A microcapsule comprising:
a hydrophobic core material within an acrylic polymeric shell;
wherein the acrylic polymeric shell was polymerized from a monomeric blend comprising:
a mono-functional acrylic monomer comprising less than 25% by weight of the monomeric blend; and
a hyperbranched polyester acrylic oligomer as the balance of the monomeric blend.

17. The microcapsule of claim 16, wherein the monomeric blend was emulsion polymerized with an azo-initiator in a first stage polymerization reaction and is subsequently further polymerized with a water soluble initiator in a second stage polymerization reaction.

18. The microcapsule of claim 16, wherein the monomeric blend further comprises a di-functional crosslinking acrylic monomer equally splitting the balance of the monomeric blend with the hyperbranched polyester acrylic oligomer.

19. The microcapsules of claim 16 wherein the mono-functional acrylic monomer comprises less than 25% by weight of the monomeric blend and the monomeric blend further comprises a di-functional crosslinking acrylic monomer equally splitting the balance of the monomeric blend with the hyperbranched polyester acrylic oligomer.

20. The microcapsules of claim 16, wherein the mono-functional acrylic monomer comprises at most 20% of the monomeric blend and the monomeric blend further comprises a di-functional crosslinking acrylic monomer equally splitting the balance of the monomeric blend with the hyperbranched polyester acrylic oligomer.
